(19) United States
(12) Patent Application Publication
(10) Pub. No.: US 2024/0152023 A1
(43) Pub. Date: May 9, 2024

(54) Wavelength Conversion Module

(71) Applicant: Nippon Telegraph and Telephone Corporation, Tokyo (JP)

(72) Inventors: Koji Embutsu, Musashino-shi, Tokyo (JP); Takeshi Umeki, Musashino-shi, Tokyo (JP); Kei Watanabe, Musashino-shi, Tokyo (JP); Osamu Tadanaga, Musashino-shi, Tokyo (JP); Takushi Kazama, Musashino-shi, Tokyo (JP); Nobutatsu Koshobu, Musashino-shi, Tokyo (JP); Takahiro Kashiwazaki, Musashino-shi, Tokyo (JP); Asuka Inoue, Musashino-shi, Tokyo (JP)

(21) Appl. No.: 18/548,995

(22) PCT Filed: Apr. 12, 2021
(86) PCT No.: PCT/JP2021/015230

§ 371 Date: Sep. 5, 2023

(51) Int. Cl. G02F 1/35; G02F 1/355

(52) U.S. Cl. CPC G02F 1/3532; G02F 1/3503; G02F 1/3551; G02F 2202/20

(57) ABSTRACT

Provided is a wavelength conversion module that can be downsized by reducing the width of the housing and can reduce the mounting space. The wavelength conversion module including a wavelength conversion element includes: a lens barrel that is provided on a side surface of a metal housing and accommodates a lens for optically coupling the wavelength conversion element to an optical fiber; and a ferrule collar that is provided on the lens barrel and fixes a metal ferrule accommodating the optical fiber, and an input port and an output port are different from each other in any of the length in the optical axis direction of a plurality of the lens barrels, the length of a plurality of the metal ferrules, or a sum length of the lens barrels and the metal ferrules.

### TECHNICAL FIELD

The present invention relates to a wavelength conversion module obtained using a second-order nonlinear optical element.

### BACKGROUND ART

The wavelength conversion technology is used in various application fields such as optical signal wavelength conversion in optical communication, optical processing, medical care, and biotechnology. The wavelength range of light to be subjected to wavelength conversion ranges from an ultraviolet range to a visible range, an infrared range, and a terahertz range, which cannot be directly outputted by a semiconductor laser. Moreover, the wavelength conversion technology is also used in applications in which a semiconductor laser cannot achieve a sufficiently high output even if the semiconductor laser can directly output the wavelength range. Also in an optical communication system, for example, a wavelength conversion technology is used for a wavelength conversion module that performs a wavelength conversion operation by difference frequency generation to be described later or an amplification operation using a parametric effect. Focusing on a material used for wavelength conversion, a wavelength conversion element using lithium niobate (LiNbO₃) that is a second-order nonlinear material and has a large nonlinear constant is widely used in commercially available light sources because of the high wavelength conversion efficiency thereof.

In the second-order nonlinear optical effect, a wavelength conversion mechanism is used in which light having a wavelength λ1 and light having a wavelength λ2 are inputted to a second-order nonlinear optical medium to generate a new wavelength λ3. Wavelength conversion expressed by the following equation is referred to as sum frequency generation (SFG).

1/λ3=1/λ1+1/λ2 Equation (1)

Moreover, assuming that λ1=λ2, wavelength conversion satisfying the following equation obtained by modifying Equation (1) is referred to as second harmonic generation (SHG).

λ3=λ1/2 Equation (2)

Furthermore, wavelength conversion satisfying the following equation is referred to as difference frequency generation (DFG).

1/λ3=1/λ1−1/λ2 Equation (3)

The wavelength λ1, the wavelength λ2, and the wavelength λ3 used at the time of difference frequency generation according to Equation (3) are referred to respectively as excitation light, signal light, and idler light. Furthermore, it is also possible to configure an optical parametric oscillator in which a nonlinear optical medium is placed in a resonator, and only the wavelength λ1 is inputted to generate the wavelength λ2 and the wavelength λ3 that satisfy Equation (3).

In recent years, with the improvement in wavelength conversion efficiency (ratio of intensity of wavelength conversion light to intensity of incident light), light amplification operation by a second-order nonlinear effect has become possible in the field of communication. This optical amplifier can perform amplification without deteriorating the signal-to-noise ratio of input light by performing a phase sensitive operation, and is expected as an optical amplifier for long-distance transmission instead of an erbium-doped fiber amplifier.

Two amplification operations in a phase sensitive amplifier are known. One is an operation using degenerate parametric amplification to input signal light and excitation light having a half wavelength of the signal light to a second-order nonlinear optical medium and amplify the signal light (e.g., refer to Non Patent Literature 1). The other is an operation using non-degenerate parametric amplification to input a pair of signal light and idler light, and excitation light having a wavelength that is a sum frequency of the signal light and the idler light and amplify the signal light and the idler light (e.g., refer to Non Patent Literature 2). The pair of signal light and idler light is generated by the difference frequency generation mechanism described above.

When a wavelength conversion technology using a second-order nonlinear optical effect is used in the communication field, difference frequency generation and parametric amplification are mainly used in the above-described mechanism based on the second-order nonlinear effect. In the difference frequency generation and the parametric amplification, since the signal light and the idler light exist in the communication wavelength band of the 1.55 μm band, the excitation light becomes light of the 0.78 μm band. Although the required level of the excitation light is lower than before due to the improvement in the wavelength conversion efficiency in recent years, the excitation light still needs to be from several hundred mW to several W.

FIG. 1 illustrates a first configuration example of a conventional wavelength conversion module. A wavelength conversion module 30 receives signal light 1 in the 1.55 μm band from a 1.55 μm band optical fiber 5, and optically couples the signal light 1 to a waveguide type wavelength conversion element 14 fixed inside a housing 21 by two lenses 9-1 and 9-2. Moreover, excitation light 2 is inputted from a 0.78 μm band optical fiber 6, and is optically coupled to the wavelength conversion element 14 by two lenses 10 and 9-2. On a side close to the wavelength conversion element 14, the common lens 9-2 is used for the 1.55 μm band and the 0.78 μm band. Moreover, in order to multiplex the 1.55 μm band light and the 0.78 μm band light, a dichroic mirror 13 that transmits the 1.55 μm light and reflects the 0.78 μm light is provided.

The 1.55 μm band light outputted from the output end of a wavelength conversion waveguide 15 formed in the wavelength conversion element 14 is optically connected with a 1.55 μm band optical fiber 8 by two lenses 11-2 and 11-1. (Amplified) signal light 4 subjected to a wavelength conversion operation is outputted from the 1.55 μm band optical fiber 8. In order to remove light in the 0.78 μm band from the output light of the wavelength conversion waveguide 15, a second dichroic mirror 16 is provided. In the wavelength conversion module of the prior art illustrated in FIG. 1, excitation light 3 in the 0.78 μm band outputted from the wavelength conversion waveguide 15 is also optically connected with a 0.78 μm band optical fiber 7 using two lenses 11-2 and 12. If 0.78 μm light can be separated from the output light subjected to the wavelength conversion operation by the dichroic mirror 16, it is not always necessary to connect the light with the 0.78 μm Docket No. 22120.283 band optical fiber 7. As the wavelength conversion element 14, for example, a waveguide type element made of lithium niobate (LiNbO₃: LN) having a periodic polarization inversion structure can be used.

As described above, in a case where the wavelength conversion module 30 in FIG. 1 is used as a phase sensitive amplifier, the input light intensity of the excitation light 2 in the 0.78 μm band from approximately several hundred mW to several W is required. On the other hand, the signal light 1 is normally attenuated in the transmission line at the stage of being inputted to the wavelength conversion module 30, and is inputted in a state where an amplification operation is required. Accordingly, the light intensity of the signal light 1 is at an extremely small level of −10 dBm or less for each wavelength. In the case of a multi-wavelength input such as a wavelength multiplex signal, the level is a sum of input light beams for the number of wavelengths.

In a pigtail module including an optical fiber for inputting and outputting light, two methods for coupling a wavelength conversion element to an optical fiber are known. First, an optical fiber is fixed to a fiber block and fixed to an end surface of a wavelength conversion element with an adhesive. Second, a wavelength conversion element is fixed to a metal housing provided with an optical window, and the metal housing and the optical fiber are welded and fixed by a YAG laser.

In order to efficiently exhibit wavelength conversion and parametric amplification using a wavelength conversion element, it is necessary to input fundamental wave light or SHG light with high input power. In a method of fixing a fiber block to a wavelength conversion element with an optical adhesive, an organic substance in the adhesive deteriorates over time due to high photon energy of input light, and therefore, an increase in connection loss is concerned. Therefore, in an optical module that inputs and outputs high-power light, a method is adopted in which an optical fiber is optically coupled to a wavelength conversion element by optical alignment, and the optical fiber and a housing are fixed by YAG welding.

In the latter method, when the optical path length in the optical system in the housing is long, dimensional tolerances of optical components such as a wavelength conversion element, a mirror, and a lens in the housing, and a shift of an imaging position due to an angular shift of a propagation beam or the like due to a positional shift at the time of fixing the optical components are likely to occur. Therefore, it is desirable to shorten the optical path length in the optical system in the housing. Thus, as illustrated in FIG. 1, a configuration has been adopted in which the input/output ports of the fundamental wave light (signal light 1, 4) and the SHG light (excitation light 2, 3) are orthogonal to each other, and the respective optical path lengths are close to each other.

Problems in the first configuration example will be described with reference to FIG. 2. A port orthogonal type module form illustrated in FIG. 1 has disadvantages that the size of the entire module is likely to increase, and in particular, the width of the housing 21 in a direction orthogonal to the propagation direction (optical axis) of light in the wavelength conversion element 14 is likely to increase. Moreover, in a case where an optical fiber is fixed to a port orthogonal type module by YAG welding, a sum length of a lens length, a fiber ferrule length, and a protective boot length is required, and in addition, a space for accommodating the optical fibers 6 and 7 to be fixed is required. Furthermore, the width W required as a mounting space of the wavelength conversion module 30 depends on the allowable bending radius R of the optical fiber to be used. Although the allowable bending radius of a general optical fiber is approximately 30 mm, it is necessary to store the optical fiber with a bending radius larger than the allowable bending radius in order to further secure the reliability of the strength of the optical fiber, and therefore, there is a problem that the mounting space is further increased.

By using a wavelength conversion element, it is possible to implement a device that exhibits various functions such as parametric amplification and phase sensitive amplification, while the waveguide type element made of LN has polarization dependency. In order to realize polarization independency required for application to optical fiber communication, it is necessary to perform wavelength conversion, parametric amplification, and phase sensitive amplification for each polarization, and therefore, a large number of wavelength conversion modules are required. Accordingly, a parametric amplification device and a phase sensitive amplification device obtained using a wavelength conversion module have a problem of increase in size.

FIG. 3 illustrates a second configuration example of a conventional wavelength conversion module. In order to avoid increase in size to be caused by a port orthogonal type module, a form in which input/output fibers are connected and fixed in a direction parallel to the optical axis of a wavelength conversion element has been studied. In a wavelength conversion module 100, an input port for inputting signal light 101 from a 1.55 μm band optical fiber 106 and an input port for inputting excitation light 102 from a 0.78 μm band optical fiber 105 are mounted on the same side surface of a housing 121. Similarly, an output port for outputting signal light 104 to a 1.55 μm band optical fiber 107 and an output port for outputting excitation light 103 to a 0.78 μm band optical fiber 108 are also mounted on a side surface of the housing 121 facing the input port.

Accordingly, the width W required as the mounting space of the wavelength conversion module 100 may be the width of the housing 121. In the second configuration example, the width W required as a mounting space can be greatly reduced as compared with the wavelength conversion module 30 illustrated in FIG. 1. However, the second configuration example also have the following problems in order to realize downsizing.

Problems in the second configuration example will be described with reference to FIG. 4. The part of the output port of the wavelength conversion module 100 illustrated in FIG. 3 is illustrated. The configuration of the input port is the same. Lens barrels 206-1 and 206-2 are provided on a side surface of a housing 221, and lenses 207 and 208 for optically coupling collimated light emitted from the wavelength conversion element or incident on the optical waveguide to optical fibers are accommodated. The lens barrels 206-1 and 206-2 are provided with ferrule collars 205-1 and 205-2 for fixing metal ferrules 204-1 and 204-2 that accommodate optical fibers 202 and 203. Note that the optical fiber 203 is already fixed.

On the other hand, a case where the optical fiber 202 is fixed to the housing 221 will be described. In order to fix the metal ferrule 204-2 to which the optical fiber 202 is fixed to the ferrule collar 205-2 of the housing 221 by YAG welding, a mechanism for holding the two individually is required. The mechanism for holding the two needs to secure sufficient strength in order to suppress fluctuation of optical characteristics during welding due to vibration or the like in a manufacturing environment. In particular, since the metal ferrule 204-2 has a small diameter and is lightweight, an optical fiber holding unit 201 having a strong structure with increased rigidity is required as a jig to be used at the time of welding in order to suppress optical fluctuation due to mechanical vibration or the like and perform highly accurate alignment.

Therefore, in a case where the optical fiber 203 is welded after one optical fiber 202 is fixed, it is necessary to avoid physical interference between the already welded optical fiber 203 and the optical fiber holding unit 201. Accordingly, on a side surface of the housing 221, the interval between output ports cannot be narrowed, and the width of the housing 221 has to be increased.

FIG. 5 illustrates a configuration example of an output port of a conventional wavelength conversion module. A difference from the case of fixing by YAG welding illustrated in FIG. 4 is the structure of an optical fiber holding unit 301. As the optical fiber holding unit 301, a holding mechanism having a reduced diameter while maintaining the minimum mechanical strength is applied, and a clearance 309 between an optical fiber 303 and the optical fiber holding unit 301 is enlarged. With this structure, interference between the two can be prevented, and the interval between output ports can be narrowed, so that a housing 321 can be downsized. However, there is a limit on the clearance 309 that can be secured due to the limit of the diameter reduction of the optical fiber holding unit 301 and furthermore the restriction of the allowable bending radius of the optical fiber, and there is a limit on reduction of the width of the housing 321 and downsizing.

### CITATION LIST

### Non Patent Literature

Non Patent Literature 1: T. Umeki, O. Tadanaga, A. Takada, and M. Asobe, “Phase sensitive degenerate parametric amplification using directly-bonded PPLN ridge waveguides, “Optics Express Vol. 19, No. 7, pp. 6326-6332, 2011
Non Patent Literature 2: T. Umeki, O. Tadanaga, M. Asobe, Y. Miyamoto, and H. Takenouchi, “First demonstration of high-order QAM signal amplification in PPLN-based phase sensitive amplifier,” Optics Express Vol. 22, No. 3, pp. 2473-2482, 2014

### SUMMARY OF INVENTION

An object of the present invention is to provide a wavelength conversion module that can be downsized by reducing the width of the housing and can reduce the mounting space.

In order to achieve such an object, an embodiment of the present invention is a wavelength conversion module including: a wavelength conversion element made of a nonlinear optical medium, in which one or both of an input port for optically coupling a plurality of input light beams from optical fibers to the wavelength conversion element and an output port for optically coupling output light from the wavelength conversion element to a plurality of optical fibers are provided on a side surface of a metal housing that stores the wavelength conversion element, the side surface being orthogonal to an optical axis of the wavelength conversion element, characterized by further including: a lens barrel that is provided on the side surface of the metal housing and accommodates a lens for optically coupling the wavelength conversion element to the optical fibers; and a ferrule collar that is provided in the lens barrel and fixes a metal ferrule accommodating the optical fibers, wherein the input port and the output port are different from each other in any one of a length in an optical axis direction of a plurality of the lens barrels, a length of a plurality of the metal ferrules, and a sum length of the lens barrels and the metal ferrules.

### BRIEF DESCRIPTION OF DRAWINGS

FIG. 1 is a diagram illustrating a first configuration example of a conventional wavelength conversion module.

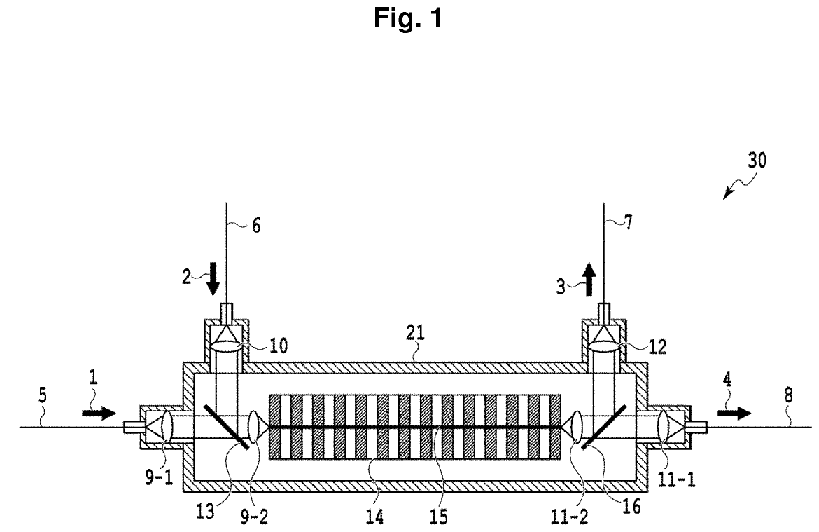

FIG. 2 is a diagram for explaining a problem in the first configuration example.

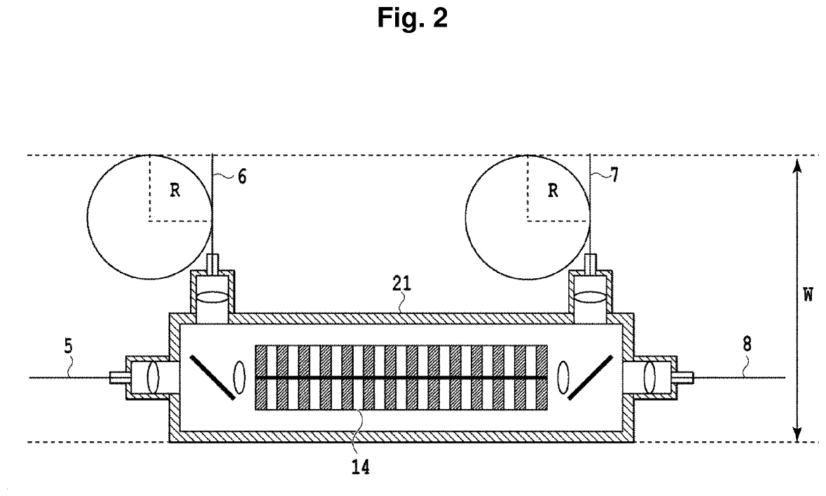

FIG. 3 is a diagram illustrating a second configuration example of a conventional wavelength conversion module.

FIG. 4 is a diagram for explaining a problem in the second configuration example.

FIG. 5 is a diagram illustrating a configuration example of an output port of a conventional wavelength conversion module.

FIG. 6 is a diagram illustrating a configuration of a wavelength conversion module according to a first embodiment of the present invention.

FIG. 7 is a diagram illustrating a configuration of a wavelength conversion module according to a second embodiment of the present invention.

FIG. 8 is a diagram illustrating a configuration of a wavelength conversion module according to a third embodiment of the present invention.

### DESCRIPTION OF EMBODIMENTS

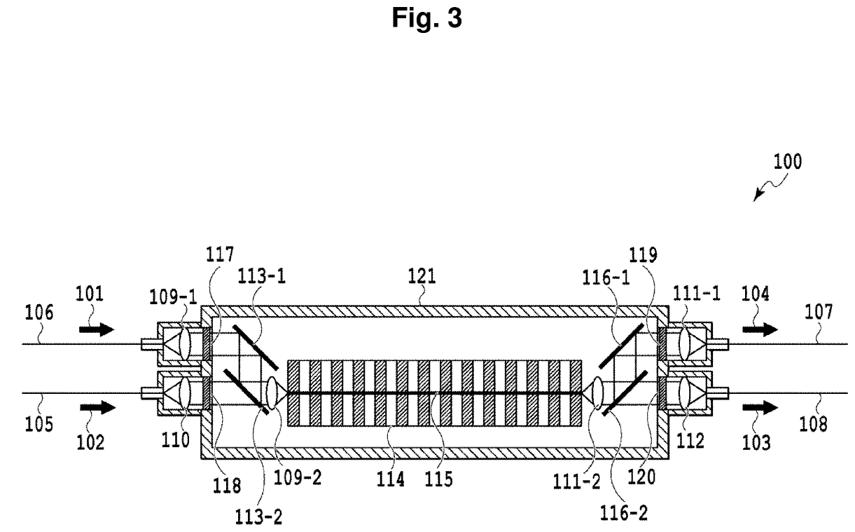

Embodiments of the present invention will be described in detail below with reference to the drawings. As described above, a wavelength conversion module according to the present embodiment includes a wavelength conversion element made of a nonlinear optical medium, and has any one of functions of generating difference frequency light, generating sum frequency light, and generating second harmonic light, by inputting excitation light and signal light and photosensitively amplifying the inputted signal light. The wavelength conversion module includes one or both of an input port for optically coupling a plurality of input light beams from optical fibers to the wavelength conversion element and an output port for optically coupling output light from the wavelength conversion element to the plurality of optical fibers. The input port and the output port are provided on a side surface of a metal housing that stores the wavelength conversion element, the side surface being orthogonal to a propagation direction (optical axis) of light in the wavelength conversion element. In the following description, an improved output port in the wavelength conversion module illustrated in FIG. 3 will be described as an example. It is clear that the present embodiment can also be applied to an input port, and it is also clear that the present embodiment can be applied to a configuration in which an input port and an output port are provided together on one side surface.

It is desirable that the nonlinear optical medium is made of any one of LiNbO₃, LiTaO₃, and LiNbₓTa₁₋ₓO₃ (0≤x≤1), or a material containing an additive of at least one selected from the group consisting of Mg, Zn, Sc, and In. An optical waveguide type device is effective as the wavelength conversion element in order to obtain a high-efficiency and broadband nonlinear optical effect, and it is desirable that the wavelength conversion element has a structure in which polarization is periodically inverted in order to perform quasi-phase matching.

### First Embodiment

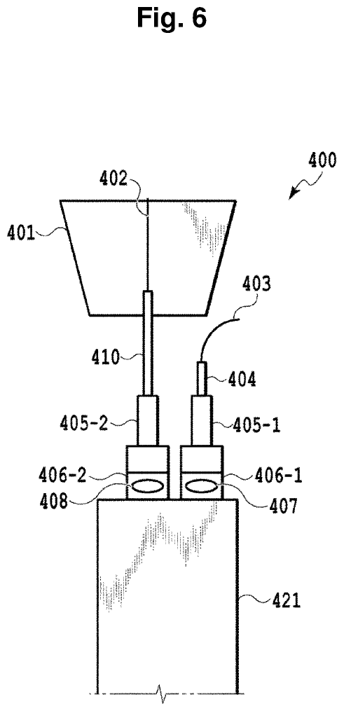

FIG. 6 illustrates a configuration of a wavelength conversion module according to the first embodiment of the present invention. A wavelength conversion module 400 is provided with lens barrels 406-1 and 406-2 on a side surface of a housing 421, and accommodates lenses 407 and 408 for optically coupling collimated light emitted from a wavelength conversion element or incident on an optical waveguide to optical fibers. The lens barrels 406-1 and 406-2 are provided with ferrule collars 405-1 and 405-2 for fixing metal ferrules 404 and 410 that accommodate optical fibers 402 and 403. Note that, in the optical fiber 403, the metal ferrule 404 and the ferrule collar 405-1 are fixed by YAG welding, already fixed to the housing 421, and optically coupled to the wavelength conversion element.

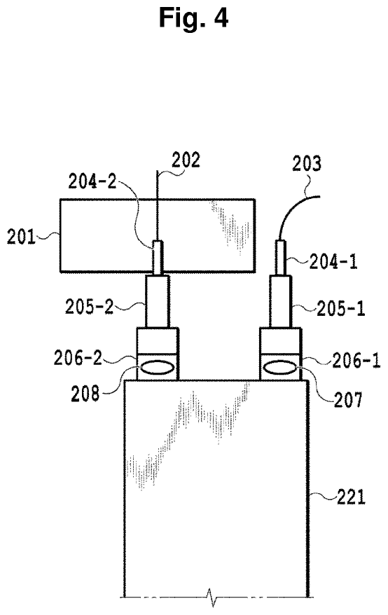

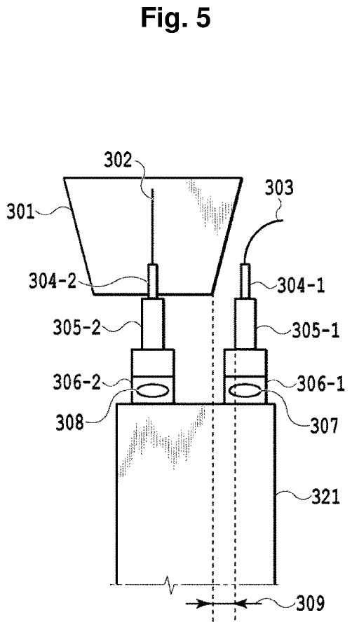

A difference between the first embodiment and the prior art illustrated in FIGS. 4 and 5 lies in the metal ferrule 410. The metal ferrule 410 is elongated substantially by the length of the allowable minimum bending radius of the optical fiber as compared with the metal ferrule 404.

In order to fix the metal ferrule 410 to which the optical fiber 402 is fixed and the ferrule collar 405-2 of the housing 421 by YAG welding, a mechanism for holding the two individually is required. The metal ferrule 410 requires an optical fiber holding unit 401 having a strong structure with increased rigidity as a jig to be used at the time of welding.

In the first embodiment, the optical fibers are fixed in order from an optical fiber having a shorter length of a metal ferrule. Since the metal ferrule 410 is elongated, it is possible to avoid physical interference between the already welded optical fiber 403 and the optical fiber holding unit 401 as illustrated in FIG. 6. Accordingly, on the side surface of the housing 421, the interval between output ports can be narrowed, the width of the housing 421 can be reduced by approximately 30%, and also, the mounting space of the wavelength conversion module 400 can be reduced.

In the first embodiment, the optical fiber 403 is a 1.55 μm band optical fiber that outputs signal light, and the optical fiber 402 is a 0.78 μm band optical fiber that outputs excitation light. That is, in order to perform alignment and fixing first from the 1.55 μm band optical fiber that outputs signal light, the optical fiber 403 is fixed first from the metal ferrule 404 to which the optical fiber 403 is fixed.

### Second Embodiment

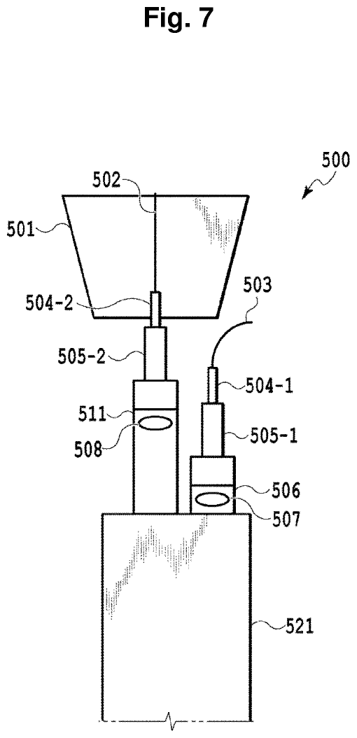

FIG. 7 illustrates a configuration of a wavelength conversion module according to the second embodiment of the present invention. A wavelength conversion module 500 is provided with lens barrels 506 and 511 on a side surface of a housing 521, and accommodates lenses 507 and 508 for optically coupling collimated light emitted from the wavelength conversion element or incident on the optical waveguide to optical fibers. The lens barrels 506 and 511 are provided with ferrule collars 505-1 and 505-2 for fixing metal ferrules 504-1 and 504-2 that accommodate optical fibers 502 and 503. Note that, in the optical fiber 503, the metal ferrule 504 and the ferrule collar 505-1 are fixed by YAG welding, already fixed to the housing 521, and optically coupled to the wavelength conversion element.

A difference between the second embodiment and the prior art illustrated in FIGS. 4 and 5 lies in the lens barrel 511. The lens barrel 511 is elongated in the optical axis direction of the wavelength conversion element substantially by the length of the allowable minimum bending radius of the optical fiber as compared with the lens barrel 506. Since light emitted from the wavelength conversion element or incident on the optical waveguide, that is, light propagating through the lens barrel is collimated light, there is no change in optical characteristics even if the length of the lens barrel is changed.

Similarly to the first embodiment, the optical fibers are fixed in the second embodiment in order from an optical fiber having a shorter length of a lens barrel. Since the lens barrel 511 is elongated, it is possible to avoid physical interference between the already welded optical fiber 503 and an optical fiber holding unit 501 as illustrated in FIG. 7. Accordingly, on the side surface of the housing 521, the interval between output ports can be narrowed, the width of the housing 521 can be reduced by approximately 30%, and also, the mounting space of the wavelength conversion module 500 can be reduced.

### Third Embodiment

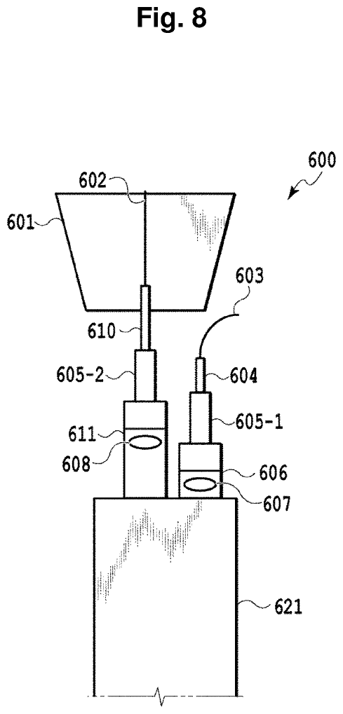

FIG. 8 illustrates a configuration of a wavelength conversion module according to the third embodiment of the present invention. A wavelength conversion module 600 is provided with lens barrels 606 and 611 on a side surface of a housing 621, and accommodates lenses 607 and 608 for optically coupling collimated light emitted from the wavelength conversion element or incident on the optical waveguide to optical fibers. The lens barrels 606 and 611 are provided with ferrule collars 605-1 and 605-2 for fixing metal ferrules 604 and 610 that accommodate optical fibers 602 and 603. Note that, in the optical fiber 603, the metal ferrule 604 and the ferrule collar 605-1 are fixed by YAG welding, already fixed to the housing 621, and optically coupled to the wavelength conversion element.

A difference between the third embodiment and the prior art illustrated in FIGS. 4 and 5 lies in the metal ferrule 610 and the lens barrel 611. The metal ferrule 610 is elongated by a length corresponding to approximately 20% of the allowable minimum bending radius of the optical fiber as compared with the metal ferrule 604. The lens barrel 611 is elongated in the optical axis direction of the wavelength conversion element by a length corresponding to approximately 80% of the allowable minimum bending radius as compared with the lens barrel 606.

Similarly to the first embodiment, the optical fibers are fixed in the third embodiment in order from an optical fiber having a shorter sum length of a metal ferrule and a lens barrel. Since the metal ferrule 610 and the lens barrel 611 are elongated, physical interference between the already welded optical fiber 603 and an optical fiber holding unit 601 can be avoided as illustrated in FIG. 8. Accordingly, on the side surface of the housing 621, the interval between output ports can be narrowed, the width of the housing 621 can be reduced by approximately 30%, and also, the mounting space of the wavelength conversion module 600 can be reduced.

With the present embodiment, the width of the housing of the wavelength conversion module can be reduced and downsized without deteriorating the wavelength conversion characteristics, and also, the mounting space of the wavelength conversion module can be reduced. Accordingly, it is possible to realize downsizing of a parametric amplification device and a phase sensitive amplification device obtained using a wavelength conversion module in addition to downsizing and densification of the wavelength conversion module.

### INDUSTRIAL APPLICABILITY

In general, the present invention can be applied to a communication system. In particular, the present invention can be applied to an optical communication device in an optical communication system.

1. A wavelength conversion module comprising: a wavelength conversion element made of a nonlinear optical medium, in which one or both of an input port for optically coupling a plurality of input light beams from optical fibers to the wavelength conversion element and an output port for optically coupling output light from the wavelength conversion element to a plurality of optical fibers are provided on a side surface of a metal housing that stores the wavelength conversion element, the side surface being orthogonal to an optical axis of the wavelength conversion element, characterized by further comprising:
a lens barrel that is provided on the side surface of the metal housing and accommodates a lens for optically coupling the wavelength conversion element to the optical fibers; and
a ferrule collar that is provided in the lens barrel and fixes a metal ferrule accommodating the optical fibers,
wherein the input port and the output port are different from each other in any one of a length in an optical axis direction of a plurality of the lens barrels, a length of a plurality of the metal ferrules, or a sum length of the lens barrels and the metal ferrules.

2. The wavelength conversion module according to claim 1, wherein the optical fibers are fixed in the input port and the output port in order from an optical fiber having a shorter length of a lens barrel, a shorter length of a metal ferrule, or a shorter sum length of a lens barrel and a metal ferrule.

3. The wavelength conversion module according to claim 1, wherein an optical fiber that propagates signal light is fixed to one of the input port and the output port that has a shorter length of a lens barrel, a shorter length of a metal ferrule, or a shorter sum length of a lens barrel and a metal ferrule.

4. The wavelength conversion module according to claim 1, wherein the nonlinear optical medium is made of any one of LiNbO3, LiTaO3, and LiNbxTa1-xO3 (0≤x≤1), or a material containing an additive of at least one selected from the group consisting of Mg, Zn, Sc, and In.

5. The wavelength conversion module according to claim 1, wherein the wavelength conversion element is of a waveguide type, and polarization is periodically inverted.

6. The wavelength conversion module according to claim 2, wherein an optical fiber that propagates signal light is fixed to one of the input port and the output port that has a shorter length of a lens barrel, a shorter length of a metal ferrule, or a shorter sum length of a lens barrel and a metal ferrule.

7. The wavelength conversion module according to claim 2, wherein the nonlinear optical medium is made of any one of LiNbO3, LiTaO3, and LiNbxTa1-xO3 (0≤x≤1), or a material containing an additive of at least one selected from the group consisting of Mg, Zn, Sc, and In.

8. The wavelength conversion module according to claim 3, wherein the nonlinear optical medium is made of any one of LiNbO3, LiTaO3, and LiNbxTa1-xO3 (0≤x≤1), or a material containing an additive of at least one selected from the group consisting of Mg, Zn, Sc, and In.

9. The wavelength conversion module according to claim 2, wherein the wavelength conversion element is of a waveguide type, and polarization is periodically inverted.

10. The wavelength conversion module according to claim 3, wherein the wavelength conversion element is of a waveguide type, and polarization is periodically inverted.

11. The wavelength conversion module according to claim 4, wherein the wavelength conversion element is of a waveguide type, and polarization is periodically inverted.
